(19) United States
(12) Patent Application Publication
(10) Pub. No.: US 2022/0291155 A1
(43) Pub. Date: Sep. 15, 2022

(54) HARD X-RAY PHOTOELECTRON SPECTROSCOPY APPARATUS

(71) Applicants: Keisuke Kobayashi, Aioi-shi (JP); Yoshiko Kobayashi, Aioi-shi (JP)

(72) Inventors: Keisuke Kobayashi, Aioi-shi (JP); Yoshiko Kobayashi, Aioi-shi (JP)

(21) Appl. No.: 17/732,301

(22) Filed: Apr. 28, 2022

Related U.S. Application Data
(62) Division of application No. 14/970,182, filed on Dec. 15, 2015, now abandoned.

(30) Foreign Application Priority Data
May 8, 2015 (JP) 2015-096104
Jun. 29, 2015 (JP) 2015-130414

(51) Int. Cl. G01N 23/2273

(52) U.S. Cl. CPC G01N 23/2273

(57) ABSTRACT

[Problem]

The present invention aims to solve the problems that size of X-ray monochromater crystal assembly is restricted and the vacuum of the X-ray source and the vacuum of the analysis chamber cannot be separated.

[Solution]

A hard X-ray photoelectron spectroscopy apparatus comprises an X-ray source, an analyzer, a sample manipulator, an analysis chamber, and vacuum evacuation systems, wherein, in a three-dimensional space defined by a XYZ rectangular coordinate axis system, a plate-like sample is arranged to be rotatable around the Z-axis by said sample manipulator (2), wherein said X-ray source comprises an electron gun (3b) which accelerates and focuses electrons, a target which is irradiated with the electrons accelerated and focused by the electron gun to generate an X-ray, monochromater crystal assembly, wherein the monochromater crystal assembly meets the Bragg condition of X-ray diffraction in X-Y plane to diffract/reflect and monochromatize the X-ray generated in said target and extract characteristic X-rays only, and on the other hand, the electron-beam-irradiation position on the target-center of the monochromater crystal assembly-center of the sample is arranged on the Rowland circle to minimize focusing aberration to the sample, the monochromater crystal assembly is located on a circle having a radius twice as large as that of the Rowland circle in a X-Y plane, preferably electron-beam-irradiation position on said target and the center of the sample are located on each of two focuses of an ellipse coming in contact with said Rowland circle in the center of the monochromater crystal assembly, said monochromater crystal assembly has a toroidal surface in Z axial direction acquired by rotating said ellipse coming in contact with said Rowland circle around a straight line connecting the electron-beam-irradiation position on said target and the center of the sample, and, a vacuum vessel for installing these components, wherein the monochromater crystal assembly used for monochromatization with diffraction and reflection of said X-ray source is located on the Rowland circle together with said target and said sample to meet the condition that the dispersed X-ray beam concentrates on the surface of the sample with the minimum aberration, wherein said Rowland circle is located to be orthogonal to the surface of the sample, wherein an optical axis of said analyzer is placed to be perpendicular (in X axial direction) to the incident direction (in Y axial direction) of the X-ray or within a range of ±36 degree angle in a X-Y plane and within a range of ±49 degree angle in a X-Z plane, wherein the sample is such that said X-ray diffracted and reflected by a reflection surface is located on focus positions on the surface of said sample and is obliquely incident on the surface of said sample, so that the spot of said X-ray elongatedly extends along a line in substantially parallel to Y axis (substantially perpendicular to X axis), and wherein an aperture of a slit provided at the entrance of said analyzer is arranged in parallel to a direction where said X-ray spot on the sample surface elongatedly extends.

### RELATED APPLICATIONS

This application claims the right of foreign priority to Japanese Patent Application No. 2015-096104, filed May 8, 2015 by at least one common inventor, and to Japanese Patent Application No. 2015-130414, filed Jun. 29, 2015 by at least one common inventor, both of which are incorporated herein by reference in their respective entireties.

### TECHNICAL FIELD

### Field of Invention

The present invention relates to a hard X-ray photoelectron spectroscopy apparatus. More particularly, the invention relates to configuration of an analyzer, a sample, and an X-ray source in a laboratory hard X-ray photoelectron spectroscopy apparatus.

### BACKGROUND

### [Photoelectron Spectroscopy]

An Electron is emitted by irradiation of high-energy light to a substance. FIG. 1 schematically shows energy state of an electron in a solid. For the sake of simplification, two atoms are depicted to be laterally bonded.

Orbits of groups of electrons orbiting with the shallowest energies have large radii and thus overlap electron orbits of the nearest neighbor atoms. This overlap provides the bonding strength, allowing the atoms to bond to become a solid. When a vacuum level (the minimum energy when a free electron is placed in a vacuum) is set to a point of origin, the electron with higher energy will be set free from restraint of atomic nucleus. Sufficiently high energy is given to the bound electron from outside by high energy photon irradiation, thereby enabling an electron wave to become free and be released from the solid surface. This is called photoelectron emission.

As shown in FIG. 2, when a solid is irradiated with an X-ray with certain photon energy, the bound electron (EL) receives that energy excited to a high-energy state, as indicated by arrows (AR), travels in the solid after freed from the restrain of atomic nucleus, reaches the surface, and are released from the surface into a vacuum.

The emitted electrons are analyzed by an energy analyzer (analyzer) (1) to obtain a spectrum reflecting the densities of bound states (left) of the electron inside the solid, which shows the electronic structure inside the sample solid and its chemical bonding property, as schematically indicated on the right side of the figure. A method of analyzing the electronic states and the chemical states using this is called photoelectron spectroscopy. High-resolution measurement using synchrotron radiation X-ray has been recently performed all over the world. A laboratory apparatus using AlK α rays (1.49 keV) as an excitation source also has been commercially available and very widely used for not only research and development but also as chemical analyses.

Thus, photoelectron spectroscopy is a very useful analytical method and has been widely used, but has a big problem. When a solid is irradiated with an X-ray, the X-ray penetrates inside of the solid to generate a photoelectron. If the photoelectron is generated at a position shallow from the solid surface, it can be released from the surface as it is without being disturbed, as shown in FIG. 3 (a). This photoelectron holds the original information (energy and momentum). On the contrary, the photoelectron generated at a deeper position would move toward the surface but collide with atoms etc. on the way and be forced to scatter. Then, the original information such as its own energy and momentum will be lost, thereby turning the photoelectron into insignificant background in a photoelectron spectrum. In conventional X-ray photoelectron spectroscopy (XPS), kinetic energy of a generated photoelectron (electron energy measured referring to the vacuum level) is small. The smaller the electron kinetic energy is, the larger the probability of the photoelectron scattering to the surface is. Therefore, the photoelectron at a deeper position cannot be released the surface without being scattered.

FIG. 4 shows average distance of photoelectrons which photoelectrons can travel without being inelastically scattered, i.e., inelastic mean photoelectron free path (IMPF), as functions of kinetic energy of photoelectrons in several solid materials. Energy of photoelectron excited by AlK α-ray (1.49 keV) is 1.49 or less keV and thus a mean free path is approximately a few nanometers or less. If the depth from the surface substantially exceeds this level, no meaningful contribution is given to a photoelectron spectrum. That is, the conventional photoelectron spectroscopy is very surface-sensitive and would measure only dirt on a sample of which surface has not been sufficiently cleaned out.

If energy of the photons used for excitation of photoelectron is higher, the kinetic energy of the photoelectron will become larger, and accordingly the mean free path of the photoelectron will also become larger, as seen in FIG. 4. If it is 6 keV, for example, the mean free path becomes several times as large as that under AlK α-ray excitation. Therefore, the influence on the surface relatively decreases and bulk sensitivity increases. Actually, when photoelectron spectroscopy was performed under 6 keV excitation using synchrotron radiation beam line, it turned out that natural oxidation layers or other contaminations of sample surface were almost negligible. This is a hard X-ray photoelectron spectroscopy, about which the inventors published an article in 2003 (Non-patent Document 1) before anyone else in the world and now has been widely used.

### PRIOR ART DOCUMENTS

### Nonpatent Documents

[Nonpatent Document 1] K. Kobayashi et al., Appl. Phys. Lett., Vol. 83, No. 5, 4, 1005, 2003
[Nonpatent Document 2] “Development of the hard-X-ray angle Resolved X-ray Photoemission spectrometer for Laboratory use”, M. Kobata, I. Pis, H. Iwai, and H. Yamazui, T. Takahashi, M. Suzuki, H. Matsuda, H. Daimon, and K. Kobayashi, ANALYTICAL SCIENCES 26 (2010) 227.
[Nonpatent Document 3] “Development of a laboratory system hard X-ray photoelectron spectroscopy and its applications” K. Kobayashi, Journal of Electron Spectroscopy and Related Phenomena 190 (2013) 210-221.

### SUMMARY OF THE INVENTION

### Problems to be Solved by the Invention

Hard X-ray photoelectron spectroscopy using synchrotron radiation is now popular to many users as a very powerful means for research and analysis of substances, but the competitive rates for obtaining a beam time are very high and application chances of the experimental proposals are opened only twice a year. Additionally, the experiment can be performed only in synchrotron radiation facilities. Therefore, a hard-X-ray photoelectron spectroscopy available in laboratories has been strongly needed.

FIG. 5 (a) shows an apparatus realizing X-ray source for hard X-ray photoelectron spectroscopy used in a laboratory (see nonpatent document 2). This apparatus is composed of a X-ray source for monochromatizing CrK α rays (5.4 keV) acquired by exciting a Cr target with an electron beam using 422 reflection of Ge crystal, focusing the light (X-rays), and irradiating a sample with the light (X-rays), an electron lens system for efficiently collecting the photoelectrons from the sample, and an analyzer for analyzing their energy distribution, as shown in FIG. 5 (a). The feature of this apparatus is to contain the X-ray source (40) mounted to a flange (50) in an analysis chamber (14), as shown in FIG. 5. This enables a very compact design. However, there will be two big problems, which is: size of the X-ray source (size of X-ray monochromater crystals) is restricted due to size of the analysis chamber, and the vacuum of X-ray source and the vacuum of the analysis chamber cannot be separated. Flux of the laboratory X-ray source is much weaker compared with synchrotron radiation, and thus there is a need for contrivance for increasing photoelectron signal intensity. This would require larger X-ray flux for irradiation to the sample and larger flux density, but electron beam output cannot be increased more than the cooling capacity of a target generating an X-ray. Therefore, any contrivance for increasing the cooling capacity of the target is essential.

Simulation result shows that when the irradiation spot to the stationary water-cooled Cr target is set to 100 microns and electron beam irradiation output exceeds 50W, sublimation of Cr will be nonnegligible. In order to increase any further electron beam output, it is necessary to use a water-cooled target rotating at high speed. In a configuration where an X-ray source is contained in an analysis chamber, incorporating the rotary target would impose great restrictions on space and mechanism, and is thus impossible. Additionally, incorporating X-rays into a monochromater crystal assembly at as large solid angle of X-ray acceptance as possible would be necessary when the X-ray is dispersed and focused on the sample. This also cannot be significantly improved due to spatial restrictions in a configuration where the X-ray source (40) mounted to a flange (50) is contained in the analysis chamber (14). Recently, experimental methods to raise the pressure in an analytical chamber to almost atmospheric pressure and observe the photoelectron spectra under controlled atmosphere, so called NAP (Near Ambient Pressure photoelectron spectroscopy) or HiPP (High Pressure Photoelectron spectroscopy) have been actively used. In this measuring method, gas is introduced into the analytical chamber, and thus X-ray source in FIG. 5 would also be exposed to gas. An electron gun contained in the X-ray source needs a high vacuum and thus would be unable to bear the gas introduction.

### Means to Solve the Problems

As a result of keen examination, the inventors have successfully solved conventional problems by solving the above problems (size of the X-ray source (i.e., size of X-ray monochromater crystals) is restricted due to size of the analysis chamber, and the vacuum of X-ray source and the vacuum of the analysis chamber cannot be separated).

The present invention aims to solve the above problems (size of the X-ray source (i.e., size of X-ray monochromater crystals) is restricted due to size of the analysis chamber, and the vacuum of X-ray source and the vacuum of the analysis chamber cannot be separated).

The hard X-ray photoelectron spectroscopy apparatus according to an aspect of the present invention comprises, in the light of the attached claims, an X-ray source (3), an analyzer (6), a sample manipulator (2), an analysis chamber (14), and vacuum evacuation systems, wherein, in a three dimensional space defined by a XYZ rectangular coordinate axis system where Z axis is defined as a direction parallel to the plane of a plate-like sample (5) and X axis and Y axis are defined as directions perpendicular to that direction, the sample (5) is arranged to be rotatable around the Z axis by the above-described sample manipulator (2) or be rotated at predetermined angle by a jig,

the above-described X-ray source (3) comprises;

an electron gun (3b) which accelerates and further focuses electrons,

a target (7) which is irradiated with the electrons accelerated and focused by the above-described focusing electron gun (3b) on to generate an X-ray,

a monochromater crystal assembly (9), wherein the monochromater crystal assembly meets the Bragg condition of X-ray diffraction in X-Y plane to diffract/reflect and monochromatize the X-ray generated in the above-described target (7) and extract characteristic X-rays only, and on the other hand, the electron-beam-irradiation position on the target (7), the center of the monochromater crystal assembly (9), and center of the sample (5) are arranged on a Rowland circle (see FIG. 9 mentioned later) to minimize focusing aberration to the sample (5), wherein Y axis is defined as an X-ray incident direction from the above-described X-ray source (3) to the sample (5), wherein the surface of the above-described monochromater crystal assembly (9) is shaped in a circle to have a radius twice as large as that of the Rowland circle in a X-Y plane, or preferably shaped in a ellipse of which one of the focuses is at the electron-beam-irradiation position on the above-described target (7) and the other is at the center of the sample (5), wherein in Z direction the monochromater crystal assembly surface has a shape which is obtained by rotating the above mentioned ellipse around the axis connecting the above mentioned two focuses to touch to the center of the monochromater crystal assembly (9), wherein the above-described monochromater crystal assembly (9) thus has a spheroidal surface that touches to the above mentioned Rowland circle at the center of the monochromater crystal assembly surface with the electron-beam-irradiation position on the above-described target (7) and the center of the sample as two of the focuses and,

a vacuum chamber (14) for installing these components,

wherein the monochromater crystal assembly (9) used for monochromatization with diffraction and reflection of the above-described X-ray source (3) is located on the Rowland circle (see FIG. 9 mentioned later) together with the above-described target (7) and the above-described sample (5) to meet the condition that the monochromatized X-ray beam focuses on the surface of the sample (5) with the minimum aberration,

wherein the above-described Rowland circle (see FIG. 9 mentioned later) is located to be orthogonal to the surface of the sample (5), wherein the sample (5) is located such that the X-ray diffracted and reflected by a reflection surface of monochromater crystals focuses on the surface of the sample (5), with incidence from Y axis on the surface of the sample (5) placed substantially perpendicular to X axis and therefore substantially parallel to Y axis, as a result, the spot of the above-described X-ray elongatedly extends along a line in substantially parallel to Y axis on the surface of the sample (5) (deviated from just oblique incidence angle), an optical axis of the above-described analyzer (6) is arranged in parallel to X axis, and an aperture of a slit (6S) provided at the entrance slit of the analyzer (6) is arranged in parallel to a direction where said X-ray elongatedly extends.

Referring to FIG. 6, a hard X-ray photoelectron spectroscopy apparatus according to an aspect of the present invention comprises an X-ray source (3), an analyzer (6), a sample manipulator (2), an analysis chamber (14), and vacuum evacuation systems, and in a three-dimensional space defined by a XYZ rectangular coordinate axis system, a plate-like sample (1) is arranged to be rotatable around the Z-axis by the above-described sample manipulator (2).

In the present invention, X-ray source conceptually comprises the target (7), the electron gun (3b), the monochromater crystal assembly (9), and the vacuum chamber (14).

The above-described X-ray source (3) comprises;

the electron gun (3b) contained in a vacuum vessel (3a) which accelerates and further focuses electrons,

the target (7) contained in a vacuum vessel (7a) which is irradiated with the electrons accelerated and focused by the above-described focusing electron gun (3b) to generate an X-ray, the monochromater crystal assembly (9) having a toroidal surface configured to be an ellipse in X-Y plane having the center of the target (7) and the center of the sample (5) as two of the focuses and a spherical surface in Z axial direction which is obtained by rotation of the above mentioned ellipse around a line connecting the center of the target (7) and the center of the sample (5), in order to diffract/reflect and monochromatize the X-ray beam (103) generated in the above-described target (7), and extract characteristic X-rays beam (105) only, and, a vacuum vessel (10) for installing these components, wherein the above-described analyzer (6) is such that its optical axis (11) is arranged perpendicular to the incident direction of X-ray (namely, X axial direction in FIG. 6), the X-ray beam (105) diffracted and reflected by the surface of the above-described monochromater crystal assembly (9) is obliquely incident on the surface of the sample (5) placed on the focus position of X-ray at a few angle through an X-ray window (13) serving also as a vacuum partition, so that the irradiation area of the above-described X-ray elongatedly extends along a line parallel to X axis on the surface of the sample (5) to turn into a photoelectron generating region, X-rays beam (105) is expanded with an electron lens (8) of an input part of the analyzer (6) and forms an elongate image on a position of aperture (107) of a slit (6S) provided at the entrance of the above-described analyzer (6), the aperture (107) of the slit (6S) of the above-described analyzer (6) was placed in parallel to the elongate photoelectron image projected on that position, the photoelectron passing through the slit (6S) is energy-analyzed at a hemispherical electrode part (10), reaches the photoelectron detection part, and is detected.

As mentioned later for the above-described configuration, it is possible to maximize the yield of photoelectron emission and the photoelectron collection efficiency in the analyzer (6). Actually, as described later, considering anisotropy of the photoelectron emission by unpolarized light X-ray irradiation generated by electron beam irradiation and attenuation due to inelastic scattering of the photoelectron within a sample, if the analyzer (6) is placed within a range of ±36 degree angle around the x axis direction in a X-Y plane and within a range of ±49 degree angle in a X-Z plane, it can secure about 65% of the photoelectron signal intensity of that the optimum configuration can secure, and thus can withstand practical use.

It is also possible to analyze depth direction based on a dependency of the photoelectron signal intensity on take off angle from the sample surface. When this approach is employed, it is possible to measure the take off angle dependence of the photoelectron intensity by placing the analyzer (6) in the optimal configuration, i.e., settling an incident direction of the X-ray to Y-axis, the optical axis of the analyzer (6) to the X direction, and the aperture of the entrance slit (6S) of the analyzer (6) parallel to Y axial direction, arranging the sample (5) at a few angle from the Y-axis so that the X-ray is obliquely incident on the surface of the sample (5), further adding a Y′ axis perpendicular to Z axis and parallel to the surface of the sample (5), rotating the sample (5) around the Y′ axis with respect to the optical axis of the analyzer (6) without substantially changing the shape of the irradiation area of the X-ray extending in parallel to the Y axis on the sample (5), thereby protecting decrease in the photoelectron collection efficiency of the analyzer (6) due to the sample rotation.

The above-described target (7) is preferably a Cr target, and Ag and Ti can also be chosen as a target when AgL α rays (2.98 keV) or TiK α rays (4.51 keV) are used.

The above-described monochromater crystal assembly (9) preferably consists of a crystal selected from a group consisting of ionic crystals such as LiF and NaCl, quartz, and semiconductors of Ge, Si, or GaAs.

When the CrK α rays are used, a reflection plane of the above-described monochromater crystal assembly (9) may be preferably a Ge422 reflection plane or a LiF222 reflection plane.

It is preferable to accelerate an electron to 20-30 keV and focus the electron beam to about spot of 100 micrometers or less with the above-described electron gun.

The hard X-ray photoelectron spectroscopy apparatus according to second aspect of the present invention is configured such that, the above-described analysis chamber (14) and the above-described X-ray source (3) are integrated, an analysis chamber part (14a) and the X-ray source (3a) are arranged in the same structure (20), a vacuum area of the analysis chamber part and the X-ray source is divided by a partition (12), the X-ray is guided through the X-ray window (13) provided at the partition (12) to the analysis chamber (14).

Additionally, the hard X-ray photoelectron spectroscopy apparatus according to third aspect of the present invention is configured such that, the X-ray source (3) is separated from the analysis chamber (14) in a vacuum, the target (7) is used as a rotary anticathode, making the best of the advantage that the target (7) can be placed outside the analysis chamber (14), and is then excited with a high-output focusing electron gun (3a), so that the intensity and the density of the X-ray flux will be higher than those obtained by using a stationary target (7) by a digit.

### Effect of the Invention

There has been two big problems in the above-described prior art, which is: size of the X-ray source (i.e., size of X-ray monochromater crystals) and size of the mechanism of a target part) is restricted due to size of the analysis chamber (6) and higher output is limited, accordingly; the vacuum of the X-ray source and the vacuum of the analysis chamber cannot be separated. In an experimental method, called NAP (Near Ambient Pressure photoelectron spectroscopy) or HiPP (High Pressure Photoelectron spectroscopy), gas is introduced into the analytical chamber and thus X-ray source (3) in FIG. 5 would also be exposed to gas, which could cause a problem that an electron gun contained in the X-ray source would be unable to bear gas introduction because it needs high vacuum.

However, the hard X-ray photoelectron spectroscopy apparatus according to the first aspect of the present invention comprises a configuration having the X-ray source and the analysis chamber separated, and thus can solve all of these problems. In the hard X-ray photoelectron spectroscopy, photoionization cross sections are smaller than those obtained in the conventional photoelectron spectroscopy, and thus it is also indispensable to practically increase the photoelectron collection efficiency as much as possible. Using the hard X-ray photoelectron spectroscopy apparatus, according to the first aspect of the present invention, it is possible not only to separate the vacuum of the X-ray source and that of the analysis chamber, but also to maximize the photoelectron collection efficiency.

The hard X-ray photoelectron spectroscopy apparatus according to the second aspect of the present invention is configured such that the above-described analysis chamber (14) and the above-described X-ray source (3) are integrated, the analysis chamber part (14a) and the X-ray source (3) are arranged in the same structure, and a vacuum area of the analysis chamber part (14a) and the X-ray source (3) is divided by the partition (12), so that it has remarkable effects that enable downsizing of the whole apparatus, separation of the vacuum areas of X-ray source (3) and the analysis chamber part (14a) (photoelectron analysis part), and maximization of the photoelectron intensity. Furthermore, it is possible to realize a configuration which can be used by changing two X-rays having different energy by applying another invention “X-ray generator and analyzer” (U.S. Pat. No. 5,550,082, inventors: KOBAYASHI, Keisuke; YAMAZUI, Hiromichi, IWAI, Hideo, OBATA, Masaaki).

According to the hard X-ray photoelectron spectroscopy apparatus according to the third aspect of the present invention, in a structure where the monochromater crystal assembly (9), the electron gun (3b) and the target (7) are separated from the vacuum area of the analysis chamber (14) and placed outside, it is possible to excite a high-speed rotating water-cooled target (7) with a high-output focusing electron gun (3b) and to realize a monochromatized CrK α-ray source with the flux intensity and flux density which are 10 times or more of an output obtained by using the stationary target (7).

### BRIEF DESCRIPTION OF DRAWINGS

FIG. 1 is an illustration schematically showing electronic energy states in a solid.

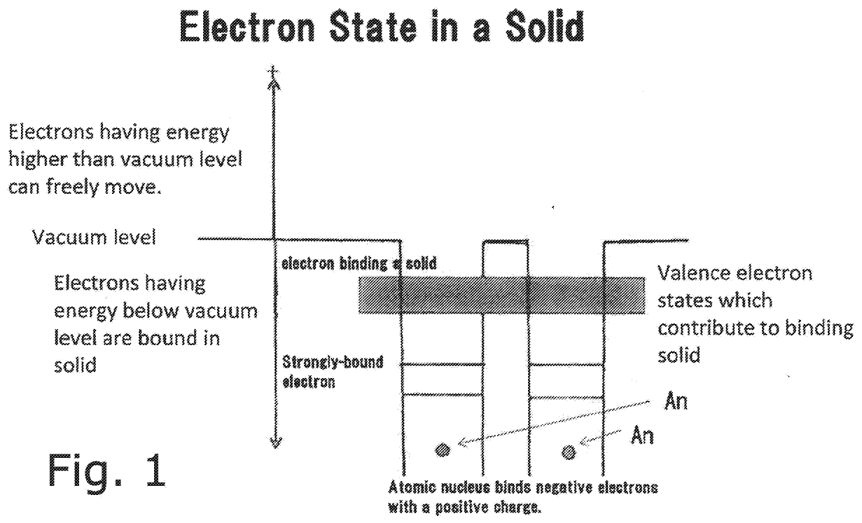

FIG. 2 illustrates the principle of photoelectron spectroscopy.

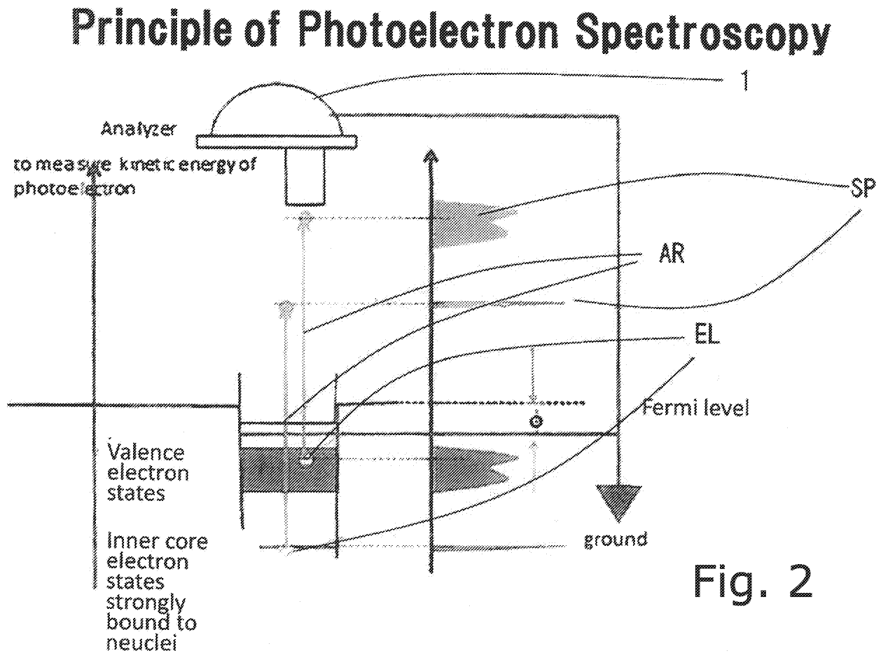

FIG. 3 illustrates a problem of photoelectron spectroscopy.

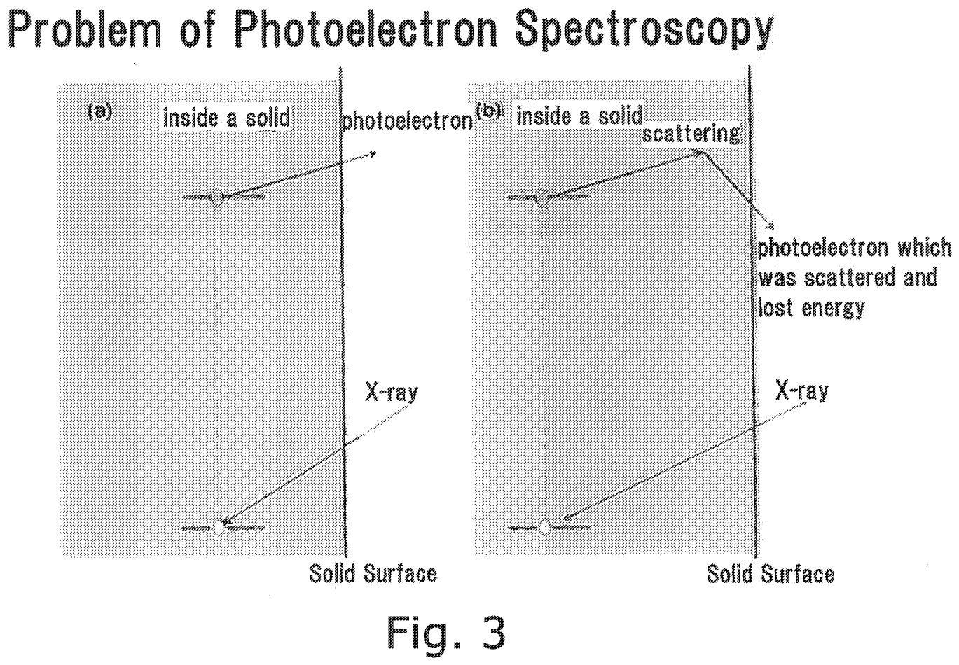

FIG. 4 is a graph showing mean free paths of electrons in solids.

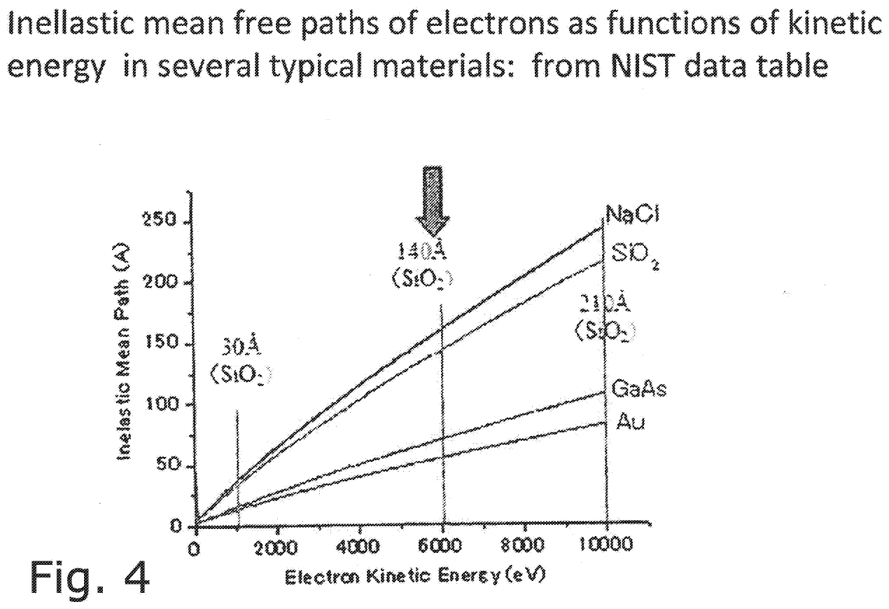

FIG. 5 is an illustration showing a conventional photoelectron spectroscopy apparatus.

FIG. 6 is an illustration showing a configuration of the photoelectron spectroscopy apparatus according to the embodiment 1 of the present invention.

FIG. 7 is an illustration explaining a principle of a monochromatized X-ray source and a geometrical relationship between the X-ray source and a sample according to the present invention.

FIG. 8 (a) is an illustration of angular dependence of photoelectron emission intensity, and FIG. 8 (b) is a schematic diagram showing special configuration of an incident direction of excitation light, a sample, and an analyzer to maximize the photoelectron signal intensity based on the angular dependence of the photoelectric emission intensity.

FIG. 9 is an illustration showing a structure including an analysis chamber part and an X-ray source part in the photoelectron spectroscopy apparatus according to the other embodiment of the present invention, in which (a) is a front view and (b) is a side view.

FIG. 10 shows angular dependence of the photoelectron emission intensity of s sub-shells (a) in an X-Y plane and (b) in an X-Z plane with unpolarized X-ray excitation, from a plate-like sample surface. Arrows show incident directions of X-rays.

FIG. 11 is a configuration of a hard X-ray photoelectron spectroscopy apparatus using an X-ray source of unpolarized light.

FIG. 12 shows a hard X-ray photoelectron spectroscopy apparatus using an X-ray source of a rotary anticathode.

### DETAILED DESCRIPTION OF THE INVENTION

### Embodiment 1

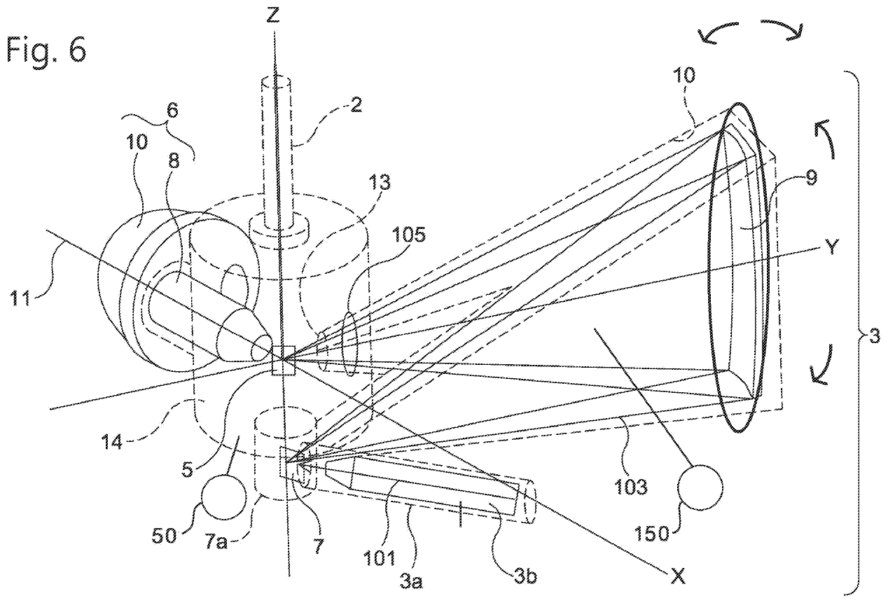

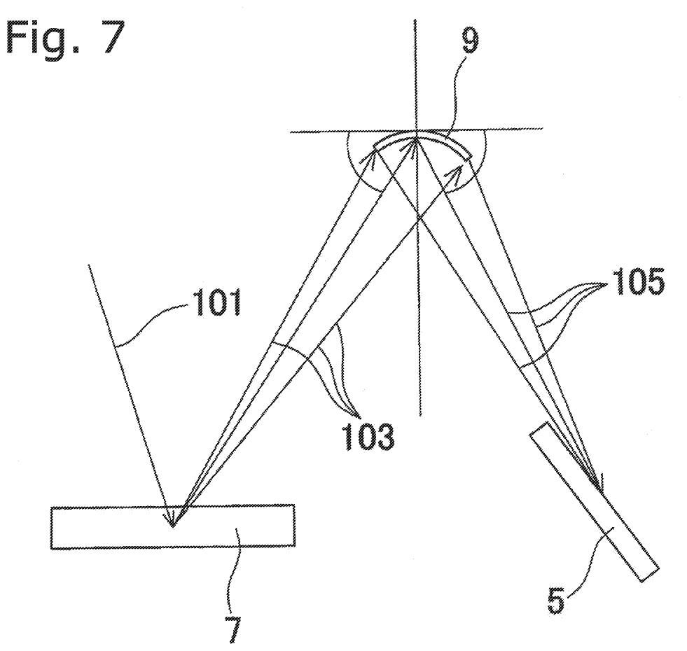

FIG. 6 is an illustration showing a configuration of the photoelectron spectroscopy apparatus according to the embodiment 1 of the present invention, and FIG. 7 is an illustration explaining a principle of a monochromatized X-ray source and a geometrical relationship between the X-ray source and a sample according to the present invention. Referring to FIG. 6 and FIG. 7, an electron beam (101) is accelerated and irradiated to a target (7) to generate an X-ray. For example, in the case of a target of Cr (hereinafter simply referred to as “Cr target”), the irradiation is typically conducted by focusing an electron beam accelerated to 20-30 keVit to about 100 microns. Then, X-ray beam (X-ray beam prior to monochromatization including a Bremsstrahlung X-ray etc.) (103) is emitted from the Cr target wherein a CrKα-ray having a peak at energy of 5.4 keV is overlapped with the Bremsstrahlung X-rays (a continuous spectrum emitted in the process where an electron slows down when it collides with the target (7)) and some emission lines such as a 1β-rays with different energies having weaker intensities than CrKα-rays.

The CrKα-ray has a wide bandwidth of about 2-3 eV, and a plurality of different specific emission lines such as Kβ-ray are included in closer energies. Also, the Bremsstrahlung X-ray extends to a high energy area and thus it cannot be used for an excitation source of photoelectron spectroscopy as it is. Thus, it is necessary to be monochromatized by X-ray diffraction with a single crystal. While the diffraction can be achieved with various kinds of crystals, an angle of diffraction (20) closer to 180 degrees is advantageous since the energy width of the monochromatized X-ray becomes wider as incident and reflection directions are separated away from the normal direction of the crystal surface. Also, it is necessary to increase the size of the monochromater crystals in order to obtain as many monochromatized X-ray fluxes as possible. Moreover, considering the performance of the spectroscopy, a good crystal with little defect and distortion is required to reduce the spectroscopic resolution.

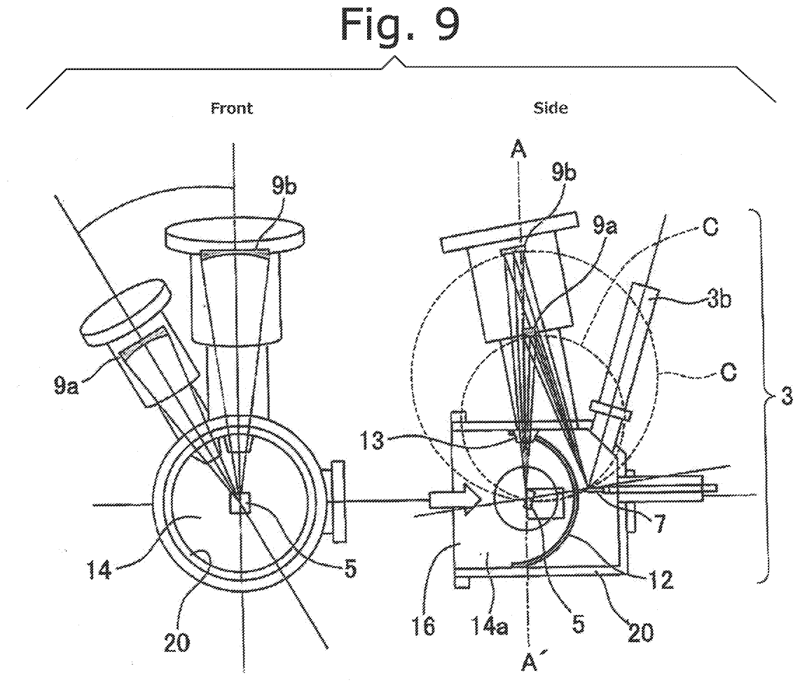

The selection of the monochromater crystals which meet the above conditions is limited. As a practical problem, crystals which are commercially available, have good crystallinities, enable large area wafer polishing, and are stable, are only ionic crystals such as LiF and NaCl, semiconductors such as Ge, Si, GaAs, and InSb and quartz, and oxides such as ZnO. Furthermore, there is a relationship among band width LE, a diffraction angle θ of the monochromatized X-ray, radius R in Rowland circle (C) (see FIG. 9 described later), and size x of a diffraction direction of a crystal, as shown in formula below.

x=\sqrt{ΔE/E}×\sqrt{2}×R tan θ [Formula 1]

Wherein, E is energy of a photon of the X-ray, and ΔE is a band width of the monochromatized X-rays. It is necessary to increase the size of the crystal in order to obtain as large X-ray flux dispersed as possible. For this purpose, it is advantageous to utilize diffraction reflection having as a large diffraction angle as possible. Under this condition, in the case of the CrKα-ray, Ge422 reflection (2θ=165.35 degrees) or LiF222 reflection (2θ=162.05 degrees) is appropriate. LiF is difficult to be handled since it has deliquescency. Thus, the inventors decided to use Ge.

A monochromater crystal assembly (9) is manufactured such that, a glass substrate has a toroidal surface polished so that an ellipse focusing on a position of the target (7) and a position of the sample (5) comes into contact with Rowland circle (C) satisfying Rowland conditions (see FIG. 9 described later) in an energy dispersion direction (diffraction direction) and so that a spherical surface is obtained by rotating the above-described ellipse around the straight line connecting the two focuses in the ellipse (i.e., the positions of the target (7) and the sample (5)) in a vertical direction (see FIG. 6), wherein Ge wafers with 422 plane, which are cut out of a Ge single crystal ingot grown by floating zone melting method and polished at the both surfaces, are fixed. Therefore, a CrKα-ray generated from the target (7) is determined to correctly focused light to a sample position with 422 diffraction reflection. Since the size of the monochromater crystals in a direction vertical to an energy dispersion direction has no influence on the X-ray band width, it is reasonable to increase the size of the crystal in this direction as long as space permits and to increase the size of the X-ray flux as large as possible.

In the case of normal incidence with a CrKα X-ray, photoelectrons are excited in an area, 10 μm deep from the surface of the sample.

However, among them, photoelectrons only in an area, about 10 nm deep from the surface of the sample (5), can escape from the surface to produce photoelectron spectrum without scattering. Therefore, most of the X-rays become useless. In order to avoid this situation, it is necessary to adopt a configuration where X-rays are preferably obliquely incident to the surface of the sample (5) and absorbed in a region as close as possible to this surface (see FIG. 7) to generate photoelectrons in the region. In practical, as the incident angle measured from the surface of the sample (5) becomes close to the total reflection angle, photoelectron intensity rises sharply.

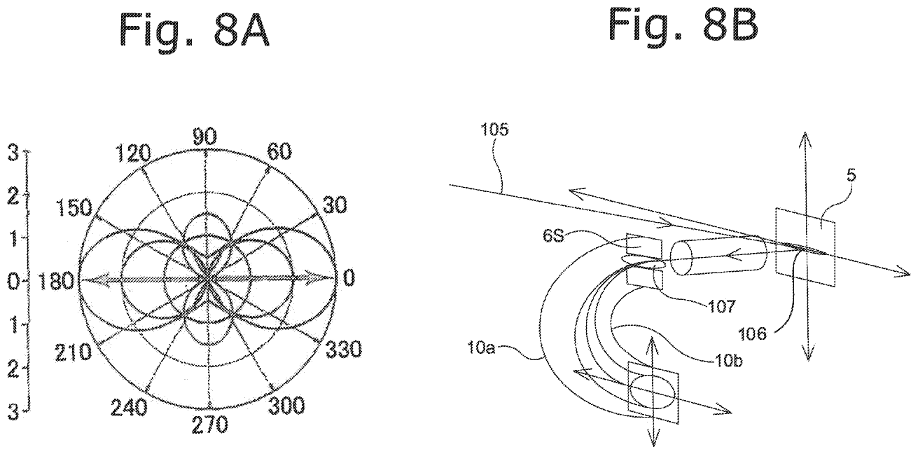

Furthermore, it is necessary to take anisotropy of emission intensity of the photoelectron into consideration. Since, in the hard X-ray photoelectron spectroscopy, consequently energies of the X-ray photoelectrons are high, the anisotropy patterns in angular intensity distribution are different from those in the conventional spectroscopy (see FIG. 8 (a)). FIG. 8 (a) is an illustration of angular dependence of photoelectron emission intensity by a linearly polarized X-ray, and FIG. 8 (b) is a schematic diagram showing an incident direction of excitation X-rays, and an spatial relationship between a sample and an analyzer based on the angular dependence of the photoelectron emission intensity.

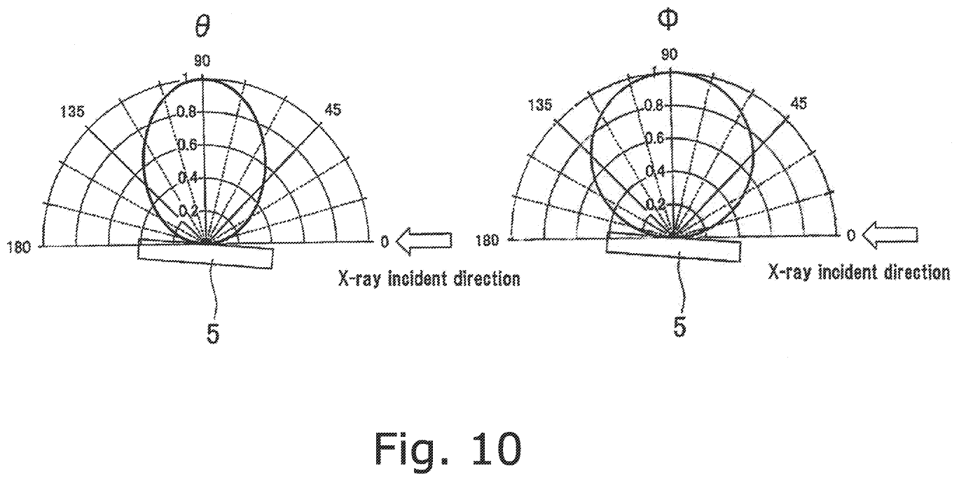

In the hard X-ray photoelectron spectroscopy, the s orbital states contribute to a spectrum the most. When an angle between an incident direction of the X-rays and an emission direction of the photoelectron is set as θ, a photoionization cross section to determine photoelectron intensity reaches to the maximum in a direction vertical to the incident direction of the X-ray (θ=90 degrees), as illustrated in FIG. 10 (a). Therefore, as illustrated in FIG. 8 (b), an axis of the analyzer (6) (X-axis, 11) is arranged rectangular to an incident direction of the X-ray (Y-axis, 101), thereby maximizing photoelectron-generating efficiency. If the sample surface is arranged to contain a Z-axis and arranged so that it is rotated a few degrees around the Z-axis and the X-rays are obliquely incident on the sample surface as close as possible, the photoelectrons are emitted in a direction substantially vertical to the sample surface and captured by the analyzer (6). Since a travel of the photoelectron within the sample (5) becomes substantially the shortest at this time, the photoelectron receives the least inelastic scattering, i.e., the photoelectron signal collected by the analyzer (6) becomes substantially the maximum. Claim 1 specifies this feature and there is no change in the description of the prior application (Tokugan 2015-96104).

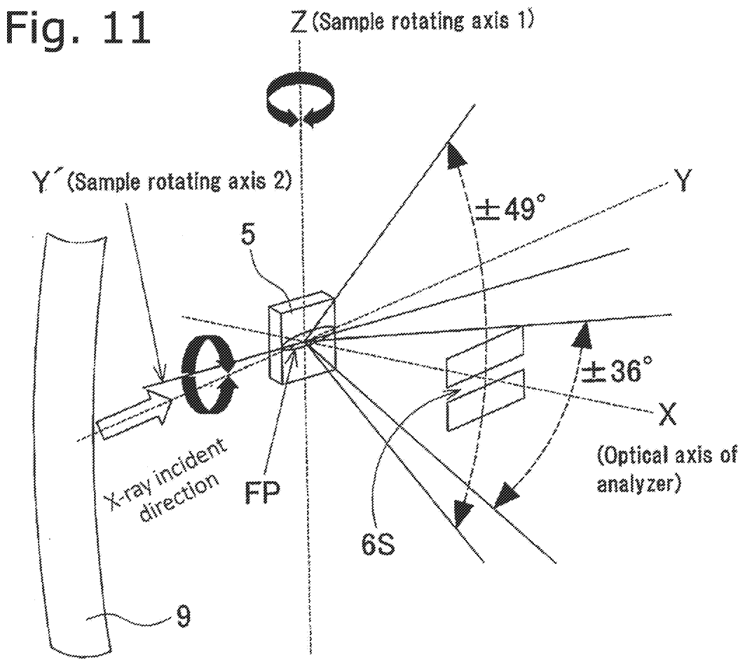

In the case of the X-ray of unpolarized light, with this configuration, in an X-Z plane determined by the X-axis and the axis (Z-axis) included in the surface of the sample (5) vertically to an incident direction of the X-ray (Y-axis), a photoionization cross section has no angular dependence. However, if the analyzer (6) is inclined from the surface of the sample (6) by angle φ, attenuation due to inelastic scattering becomes large, so that intensity of the photoelectron collected by the analyzer (6) has angular dependence indicated in FIG. 10 (b). From above, in order to maximize photoelectron intensity, with setting the incident direction of the X-ray as a Y-axis and accordingly the optical axis of the analyzer (6) as a X-axis, it is necessary to arrange the sample (5) on the conditions as close to total reflection as possible in the range permitting spread angle of the X-ray around the Z-axis for the Z-axis included in the sample surface and vertical to the Y-axis. On the other hand, in practical, intensity loss for about 65% of intensity obtained by this optimum configuration is acceptable. Thus, as shown in FIG. 11, if the optical axis of the analyzer (6) is arranged in the range of ±36 degrees around the X axial direction within the X-Y plane and ±49 degrees within the X-Z plane, it can withstand practical use (claim 7 specifies this feature). On the other hand, the X-ray is obliquely incident on the sample (5) surface very close. Thus, in order to efficiently collect a photoelectron into the analyzer (6), an aperture (107) of a slit (6S) will be in parallel to a direction where the photoelectron image elongatedly extends. Referring to FIG. 6, the photoelectron is guided to a hemispherical analyzer part (10) by electron lens (8). An entrance slit (6S) is provided between the hemispherical analyzer part (10) and the electron lens (8).

As described in detail above, the larger a take off angle of the photoelectrons from the sample (5) (measured from a direction perpendicular to the sample surface) becomes, the more photoelectron intensity is attenuated, and there is a technique utilizing this effect to analyze a depth profiles of compositions and chemical bonding states of the sample from the take off angle dependence of photoelectron intensity. In the case where the sample is rotated around the Z-axis by an application of this technique to the laboratory hard X-ray photoelectron spectroscopy, the conditions for oblique incidence of the X-ray into the sample (5) are broken, leading to extreme attenuation of signal intensities along with the escape angle. This problem can be relieved by changing the take off angle with an axis (Y′-axis) which rotates the sample being provided in a longitudinal direction of an elongated footprint of X-rays on the sample.

With a laboratory X-ray light source, the X-rays emitted from the target become spread according to a cosine rule. In order to take in this largely spreading X-rays as much as possible, the size of the monochromater crystal assembly in a direction vertical to an energy dispersion direction is increased as much as possible. In practical, at 730 mm in diameter of the Rowland circle (C) (see FIG. 9 described later) using the Ge422 reflection which is an embodiment of the present invention, if the design value of the X-ray band width is set to be 0.3 eV, the size of the monochromater crystals in the energy dispersion direction becomes 50 mm. On the other hand, due to the spatial restriction by other apparatuses attached to the analysis chamber, the size of the monochromater crystal assembly in a direction vertical to the energy dispersion direction is limited to 220 mm. That is, monochromatized X-ray beam to be obtained is incident on the sample with 4 degrees of the angle width in the energy dispersion direction and 17 degrees in the direction vertical to the energy dispersion direction. In this example, as shown in FIG. 6, the X-ray beam is arranged to be obliquely incident from a direction with a small spread of the X-rays to the surface of the sample (5) placed vertical to the plane (X-Y plane in FIG. 6) including the Rowland circle (C) (see FIG. 9 described later) at an angle substantially close to the Y axial direction in FIG. 6, so that the use of the X-ray flux is optimized.

Also, the laboratory X-ray source is unpolarized light, and thus, when we attempt to satisfy these conditions in a laboratory, an optimal relative spatial configuration of an X-ray source (3)-analyzer (6)-sample (5) is determined uniquely (see FIG. 6). That is, the Rowland circle (see FIG. 9 described later) determining a relative geometrical relationship of a sample (5)-monochromater crystal (9)-target (7) and the surface of the sample (5) are arranged to be orthogonal, allowing for X-rays from the X-ray source (see FIG. 6) to be obliquely incident on the surface of the sample (5) at as low angle as possible. This configuration allows for an incident angle to the sample (5) of the X-ray beam to be about half of 4 degrees of a spread width of the X-ray beam. At this time, since an X-ray spot elongatedly extends in an energy dispersion direction of an X-ray spectrometer on the sample (5), the analyzer (6) is arranged so that the entrance slit (6S) is parallel to this direction. In order for a target part (7) and an electron gun part (9) of the X-ray source (3) to be located outside of the analysis chamber (14), it is required that the sizes of the Rowland circle (C) (see FIG. 9 described later) and the monochromater crystal assembly (9) be adjusted so that a distance between the target (7) and the focus point of the X-ray source (3) on the sample surface is longer than the radius of the analysis chamber (14), and that the target be designed to be placed outside of the analysis chamber (14). As described in detail above, the laboratory X-ray source is unpolarized light and there is no angular dependence of the photoionization cross section by an X-ray in the X-Z plane. But escape depth of a photoelectron changes, and thus, if the optical axis of the analyzer (6) is inclined from the surface of the sample (5) by φ, photoelectron intensity changes according to sin φ as shown in FIG. 10 (b). In addition, the photoionization cross sections change in angle in the X-Y plane as seen in FIG. 10 (a). Accordingly, even if the optical axis configuration of the above-mentioned analyzer is displaced by about ±49 degrees from the direction vertical to the sample surface in the X-Z plane or by about ±36 degrees in the X-Y plane, intensities decrease by only about 65% of the optimum configuration, leading to no significant loss in practical.

Since a cylinder type of the analysis chamber as shown in FIG. 6 is used as a standard analysis chamber (vacuum chamber) (14), a relative configuration of each component is determined as shown in FIG. 6. The configuration will be basically the same even if a spherical chamber is used as an analysis chamber (14). The most important factor determining the configuration is that the crystal assembly of the X-ray spectrometer is small with respect to the energy dispersion direction and is long-extending to the direction vertical to the energy dispersion direction.

With this shape, the purpose of taking in as many X-ray fluxes as possible is achieved (it is because that, if the crystal is enlarged to the energy dispersion direction, monochromaticity of the X-ray becomes deteriorated, and thus the crystal only in the direction vertical to the energy dispersion direction is enlarged). If sizes of the both crystals are decreased at the sacrifice of X-ray flux, this configuration is no longer limited, but the practicality will be decreased. Even if LiF222 is used instead of Ge422, a relative configuration will be uniquely determined in a similar manner. There are other characteristic X-rays which can be used for hard X-ray photoelectron spectroscopy, such as Ag—Lα rays (2.98 keV) and Ti-Kα rays (4.51 keV) as well as a CrKα-ray. However, relatively considering the obtained band width of the X-ray and intensity of the X-ray beam, etc., CrKα-ray has the highest practicality when combined with the monochromater crystals.

### Embodiment 2

Another embodiment will be explained below which satisfies the conditions for the above-mentioned spatial configurations.

The inventors adopts in this embodiment the knowledge relating to another invention “X-Ray Generator and Analyzer” (U.S. Pat. No. 5,550,082; Inventors: KOBAYASHI, Keisuke, YAMAZUI, Hiromichi, IWAI, Hideo, and KOBATA, Masaaki), in which a configuration of the double-ray source switching and utilizing an AlKα-ray and CrKα-ray is suggested.

FIG. 9 shows an apparatus of this embodiment. This embodiment has a structure in which the analysis chamber and the X-ray source are integrated and the vacuum of the analysis chamber part and that of the X-ray source are divided by a partition to lead the X-ray through an X-ray window provided at the partition to the analysis chamber.

The target (7) is irradiated with an electron beam by the electron gun (3b) to generate an X-ray. There is an area coated with Al and Cr on the substrate of the target (7). The target (7) is linearly movable in a direction, allowing for a to-be-irradiated area with an electron beam to be selected for Al or Cr coated part. This allows for the AlKα-ray or CrKα-ray to be selected and generated. Each X-ray is monochromatized by monochromater crystals for AlKα-ray (9a) or monochromater crystals for CrKα-ray (9b) and arranged to be obliquely incident on the surface of the sample (5). In this case, a Rowland circle of a spectroscope for AlKα-ray and CrKα-ray is designed to intersect at the same two points, i.e., a position of the target (7) and a position of the sample (5). Thus, whichever X-rays are selected, the focusing position of the X-rays does not change and it is not necessary to readjust the positions of the sample (5) and the analyzer (6) (see FIG. 6). A vacuum system (i.e., analysis chamber part (14a)) of a space (14a) around the X-ray generation part (3b) monochromater crystal part (9) including the target (7) (i.e., X-ray source part (3)) and the sample (5) is separated by a partition (12). Also, the CrKα-ray is led through the X-ray transmitting window (13) provided at this partition (12) to the sample, and, in the configuration of FIG. 9, is obliquely incident from upwards to the sample surface and forms a vertically elongated irradiation area on the sample surface.

In order to efficiently receive photoelectrons emitted from this elongated area with the analyzer, the aperture (107) of the entrance slit (6S) of the analyzer (6) enables the analyzer (6) (see FIGS. 6 and 7) to be attached to an aperture (ICF253 flange) (16) of the analysis chamber part (14a) so that the aperture (107) extends in a vertical direction. Since the X-ray irradiation area in the sample (5) elongatedly extends in an oblique direction for an AlKα-ray, in-take efficiency of the photoelectron into the analyzer (6) (FIGS. 6 and 7) becomes somewhat deteriorated. However, in general, an AlKα-ray has a sufficiently larger photoionization cross section compared with a CrKα-ray, and thus, it can obtain sufficiently strong signal intensity. Also, since an AlKα-ray has low energy, a penetration depth into the sample is extremely shallow compared with a CrKα-ray. Therefore, it is relatively less necessary for X-rays to be obliquely incident in order to increase photoelectron intensity. If an X-ray incident angle to the sample is increased, an extension of the X-ray spot on the sample surface will become short. Accordingly, this problem practically has no big influence. In addition, if there is sufficient photoelectron signal intensity, it is also possible to improve in-take efficiency of the photoelectron in the aperture (107) of the slit (6S) by suppressing output of the electron gun (3b) and decreasing the size of the X-ray spot.

According to the embodiment 2, superior effects can be achieved which satisfy all of the followings; to make the whole apparatus compact; to separate the vacuum of the X-ray source (3a) and that of the analysis chamber part (photoelectron analysis part) (14a); and to maximize photoelectron intensity. This allows for an application to a HiPP/NAPP measuring device. Furthermore, since the size of the Rowland circle (C) of the X-ray spectrometer could be decreased to the half of the embodiment 1, decreasing the required area of the monochromater crystal (9) assembly to one fourth, there is also an advantage that the cost can be significantly lowered. Such advantage can be achieved by a design where the analysis chamber (14) and the X-ray source (3) are integrated while the vacuums are separated.

### Embodiment 3

Yet another embodiment will be explained below which satisfies the conditions for the above-mentioned spatial configuration. In the embodiment 1, in order to achieve large X-ray flux, a structure is adopted which achieves a large acceptance angle of the monochromater crystal assembly, but there is a spatial restriction for this structure. It is considered that the output of the electron gun (3b) exciting the target for further increase of the X-ray flux is increased. However, if the output of the electron beam is increased exceeding the cooling capacity of the target (7), the target layer (7) will be damaged, since the most of energy of the electron beam turn into heat within the target layer (7). If the size of the spot (footprint (FP)) on the target (7) of the electron beam is increased, the density of the generated heat decreases, thereby preventing the damage to the target (7). However, the spot size on the target (7) of the electron beam corresponds to the size of the X-ray spot (footprint (FP)) on the sample (5) as it is, which degrades energy resolution and spatial resolution of the photoelectron spectrum. Also if the spot (footprint (FP)) size on the sample increases, a photoelectron image which is enlarged by the electron lens (8) of the analyzer (6) and projected on the entrance slit (6S) of the analyzer (6) becomes larger than the aperture of the slit (6S), resulting in a decrease in photoelectron signal intensity detected by the analyzer (6).

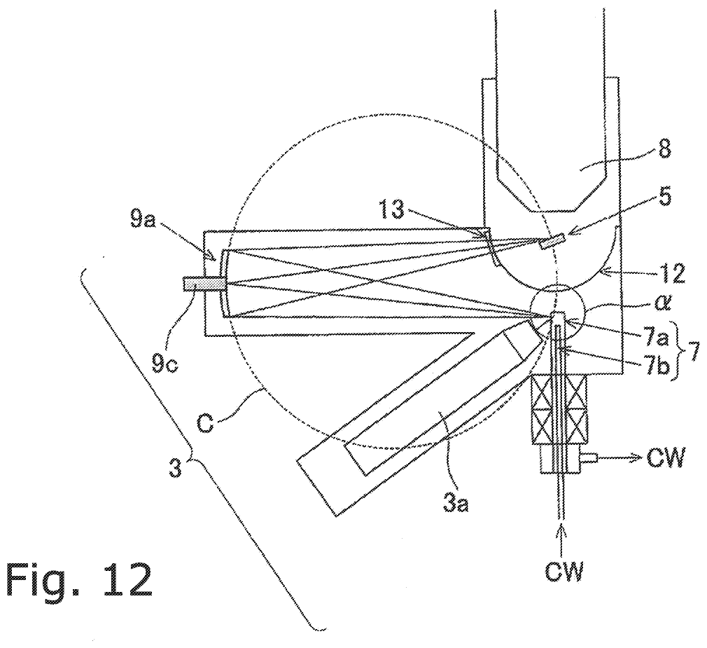

In order to fulfill the requests to sustain the spot (footprint (FP)) size on the target (7) of the electron beam to 100 microns or less and increase X-ray intensity, paying attention to the area enclosed by the sign a in FIG. 12, the X-ray source (3) was configured to use the target (7) as a rotating anticathode. In the configuration, a cooling-water (CW) channel is circulated in the target (7a) in which a Cr thin film is formed on a cylinder made of a material with good thermal conductivity, i.e., in this example, oxygen free copper (Oxygen Free Cupper, OFC) having cooling water channel (7b) provided therein (built in). The above-mentioned cylindrical target (7) is configured to enable 6500 rpm of high-speed rotation by a coaxial motor while sealing a vacuum with a magnetic fluid seal and sealing the cooling-water channel with a mechanical seal. The Cr thin film of the cylindrical target (7a) was irradiated with 30 keV of acceleration voltage, 20 mA, and 100 μm of the spot size by the high-output focusing electron gun, thereby stably obtaining a monochromatized X-ray flux with about 10 times more intensity than that of the stationary ray source in the embodiment 1.

The rotating anticathode type of the X-ray source has been commonly used for an X-ray diffractometer, etc. and already been the known art. It is configured to accelerate electron rays generated from a linear filament and irradiate an elongated area on a target by focusing the electron beam in a one-dimensional direction by a simply-structured electrode, and extract them out from a direction along a long-extending X-ray generation area at a low angle (typically 6 degrees). This known system has an advantage that an apparent spot size of an X-ray can be decreased by the simply-structured electron gun. But on the other hand, the rate of utilization of the X-ray is low and the obtained X-ray flux is decreased for increased output of the electron gun, which does not meet the purpose of this embodiment. Here, in the rotating anticathode type of the X-ray source in this embodiment 3, unlike these known systems, a hard X-ray photoelectron spectroscopy with high throughput was achieved by irradiating the target with an electron gun (3b) equipped with convergent lens which can two-dimensionally focused electron beam to about 100 microns or less and generating 100-micron size of focusing X-ray spot with high intensity.

### INDUSTRIAL APPLICABILITY

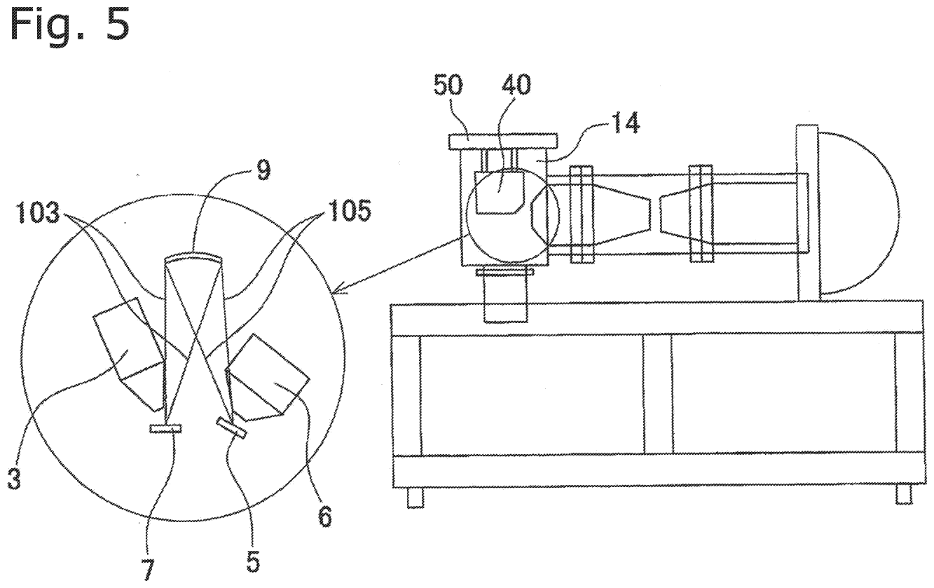

In the above-mentioned conventional art, there were two big problems that the size of the X-ray source (i.e., the size of the monochromater crystals of the X-ray, and the size and structure of the target mechanism) is limited due to the size of the analysis chamber and that the vacuum of the X-ray source and that of the analysis chamber cannot be separated. Also, in an experimental technique referred to as NAP (Near Ambient Pressure Photoelectron spectroscopy) or HiPP (High Pressure Photoelectron spectroscopy), gas is introduced into an analysis chamber. In this situation, the X-ray source in FIG. 5 is exposed to gas. And there was a problem here that the electron gun contained in the X-ray source is not capable of withstanding the introduction of gas since it requires a high vacuum. However, according to the present invention, it is possible to separate the X-ray source and the analysis chamber, thereby solving all of these problems. This allows for applications of the photoelectron spectroscopy to not only various solid materials but also liquid, gas, solid-gas interface, solid-liquid interface, etc. This enables applications to basic research, research and development, evaluation analysis, production control, etc. beyond the conventional frame to significantly improve the industrial applicability.

### EXPLANATION OF NUMERALS

2 Sample Manipulator
3 X-Ray Source
3a Vacuum Vessel
3b Electron Gun (One Element of the X-Ray Source)
5 Sample
6 Analyzer
6S Slit
7 Target (One Element of the X-Ray Source)
7a Cylindrical Body Consisting of Cr Thin Film
7b Water Channel
8 Electron Lens of Analyzer
9, 9a, and 9b Monochromater Crystal Assembly (One Element of the
X-Ray Source)
10 Hemispherical Analyzer
11 X-Axis of Analyzer
12 Partition
13 X-Ray Window
14 Analysis Chamber (Vacuum Chamber)
14a Analysis Chamber Part
20 Structure
101 Electron Beam
103 X-Ray Beam Prior to Monochromatization (including such
as Bremsstrahlung X-ray)
105 X-Ray Intruding into Sample
C Rowland Circle
FP Footprint

1.-25. (canceled)

26. A hard X-ray photoelectron spectroscopy apparatus, comprising:
an X-ray source;
an analyzer;
a sample manipulator;
an analysis chamber; and
vacuum evacuation systems;
wherein, in a three-dimensional space defined by a XYZ coordinate axis system, a plate-like sample is arranged to be rotatable around the Z axis by said sample manipulator;
wherein said X-ray source comprises:
an electron gun that accelerates and further focuses electrons;
a target that is irradiated with the electrons accelerated and focused by said focusing electron gun to generate an X-ray;
a monochromator crystal assembly, wherein the monochromator crystal assembly meets the Bragg condition of X-ray diffraction in X-Y plane to diffract/reflect and monochromatize the X-ray generated in said target and extract characteristic X-rays only, and the electron-beam-irradiation position on the target, a center of the monochromator crystal assembly, and the sample are arranged on the Rowland circle to minimize focusing aberration to the sample, wherein electron-beam-irradiation position on said target and the center of the sample are located on each of two focuses of an ellipse coming in contact with said Rowland circle in the center of the monochromator crystal assembly, said monochromator crystal assembly has a toroidal surface in Z axial direction acquired by rotating said ellipse coming in contact with said Rowland circle around a straight line connecting the electron-beam-irradiation position on said target and the center of the sample; and
a vacuum vessel for installing the electron gun, target, and monochromator crystal assembly;
wherein the monochromator crystal assembly used for monochromatization with diffraction and reflection of said X-ray source is located on the Rowland circle together with said target and said sample to meet the condition that the dispersed X-ray beam concentrates on the surface of the sample with the minimum aberration;
wherein said Rowland circle is located to be orthogonal to the surface of the sample;
wherein an axis of said analyzer is to be within an angle range of 90+15 degree to the incident direction of the X-rays;
wherein the sample is located such that said X-rays diffracted and reflected by the reflection surface of the monochromator crystal assembly focus on the surface of said sample and are obliquely incident on the surface of said sample, so that the spot of said X-rays elongatedly extends along a line in substantially parallel to X axis;
wherein a slit aperture provided at an entrance of said analyzer is arranged in parallel to a direction where said X-ray elongatedly extends;
wherein said monochromator crystal assembly consists of one kind of crystal selected from a group consisting of ionic crystals including LiF or NaCl, and semiconductors including Ge, Si or GaAS; and
wherein said analysis chamber and said X-ray source are integrated, an analysis chamber part and the X-ray source are arranged in a same structure, vacuum regions of the analysis chamber part and the X-ray source are divided by a partition, the X-rays are guided through an X-ray window provided at the partition to the analysis chamber.

27. The hard X-ray photoelectron spectroscopy apparatus according to claim 26, wherein said target is a Cr target.

28. The hard X-ray photoelectron spectroscopy apparatus according to claim 26, wherein a reflection plane of said monochromator crystal assembly is a Ge422 reflection plane or a Li222 reflection plane.

29. The hard X-ray photoelectron spectroscopy apparatus according to claim 26, wherein an electron is accelerated to 20-50 keV and focused to about 100 micrometers or less with said electron gun.

30. The hard X-ray photoelectron spectroscopy apparatus according to claim 26, wherein in said X-ray source, the target irradiated by said electron gun is a high speed-rotatable water-cooled anticathode and can keep the size of the light source small, after the generated X-ray is captured from the surface at high angle.

31. A hard X-ray photoelectron spectroscopy apparatus comprising,
an X-ray source;
an analyzer;
a sample manipulator;
an analysis chamber; and
vacuum evacuation systems;
wherein, in a three-dimensional space defined by a XYZ rectangular coordinate axis system, a plate-like sample is arranged to be rotatable around the Z-axis by said sample manipulator, wherein said X-ray source comprises an electron gun which accelerates and focuses electrons, a target which is irradiated with the electrons accelerated and focused by the electron gun to generate an X-rays;
a monochromator crystal assembly, wherein the monochromator crystal assembly meets the Bragg condition of X-ray diffraction in X-Y plane to diffract/reflect and monochromatize the X-rays generated in said target and extract characteristic X-rays only, and on the other hand, the electron-beam-irradiation position on the target-center of the monochromator crystal assembly-center of the sample is arranged on the Rowland circle to minimize focusing aberration to the sample, the monochromator crystals are located on a circle having a radius twice as large as that of the Rowland circle in a X-Y plane, wherein electron-beam-irradiation position on said target and the center of the sample are located on each of two focuses of an ellipse coming in contact with said Rowland circle in the center of the monochromator crystal assembly, said monochromator crystal assembly has a toroidal surface in Z axial direction acquired by rotating said ellipse coming in contact with said Rowland circle around a straight line connecting the electron-beam-irradiation position on said target and the center of the sample;
wherein the monochromator crystal assembly used for monochromatization with diffraction and reflection of said X-ray source is located on the Rowland circle together with said target and said sample to meet the condition that the dispersed X-ray beam focuses on the surface of the sample with the minimum aberration;
wherein said Rowland circle is located to be orthogonal to the surface of the sample;
wherein an optical axis of said analyzer is placed to be perpendicular (in X axial direction) to the incident direction (in Y axial direction) of the X-rays or within a range of ±36 degree angle in a X-Y plane and within a range of ±49 degree angle in a X-Z plane;
wherein the sample is located such that said X-rays diffracted and reflected by the reflection surface of the monochromator crystal assembly focus on the surface of said sample and are obliquely incident on the surface of said sample, so that the spot of said X-ray elongatedly extends along a line in substantially parallel to Y axis (substantially perpendicular to X axis);
wherein a slit aperture provided at the entrance of said analyzer is arranged in parallel to a direction where said X-ray spot on the sample surface elongatedly extends; and
wherein said analysis chamber and said X-ray source are integrated, an analysis chamber part and an X-ray source part are arranged in a same structure, vacuum regions of the analysis chamber part and the X-ray source part is divided by a partition, the X-rays are guided through an X-ray window provided at the partition to the analysis chamber.

32. The hard X-ray photoelectron spectroscopy apparatus according to claim 31, wherein said target is a Cr target.

33. The hard X-ray photoelectron spectroscopy apparatus according to claim 31, wherein said monochromator crystal assembly consists of one kind of crystal selected from a group consisting of ionic crystals including LiF or NaCl, and semiconductors including Ge, Si or GaAS.

34. The hard X-ray photoelectron spectroscopy apparatus according to claim 31, wherein a reflection plane of said monochromator crystal assembly is a Ge422 reflection plane or a Li222 reflection plane.

35. The hard X-ray photoelectron spectroscopy apparatus according to claim 31, wherein an electron is accelerated to 20-50 keV and focused to about 100 micrometers or less with said electron gun.

36. The hard X-ray photoelectron spectroscopy apparatus according to claim 31, wherein in said X-ray source, the target irradiated by said electron gun is a high speed-rotatable water-cooled anticathode and can keep the size of the light source small, after the generated X-ray is captured from the surface at high angle.
